(19) United States
(12) Patent Application Publication
(10) Pub. No.: US 2004/0099083 A1
(43) Pub. Date: May 27, 2004

(54) Steering column structure of a vehicle

(76) Inventors: In-Ho Choi, Gyeonggi-do (KR); Ki-Chang Kim, Gyeonggi-do (KR)

Correspondence Address: MORGAN, LEWIS & BOCKIUS, LLP., 3300 HILLVIEW AVENUE, PALO ALTO, CA, 94304, US

(21) Appl. No.: 10/701,924

(22) Filed: Nov. 4, 2003

(30) Foreign Application Priority Data
Nov. 27, 2002 (KR) 2002-74292

(51) Int. Cl. B62D 1/16

(52) U.S. Cl. 74/492; 74/493

(57) ABSTRACT

A steering column structure of a vehicle comprises an upper shroud placed toward the upper part of a steering column, whose top section is parallel or tapers off from a part contacting a crash pad toward an operational line of the steering column collapse; and a lower shroud formed with a depression at a place near a driver's knees and a central part of the steering column, such that the safety of passengers is enhanced during a vehicle collision.

### CROSS-REFERENCE TO RELATED APPLICATIONS

This application claims priority of Korean Application No. 10-2002-0074292, filed on Nov. 27, 2002, the disclosure of which is incorporated fully herein by reference.

### FIELD OF THE INVENTION

The present invention relates to a steering column structure of a vehicle and, more particularly, to a steering column structure adapted to minimize injury to a driver when a collision occurs and to decrease vibration and noise generated from the steering shaft while a vehicle is in motion or in an idle state.

### BACKGROUND OF THE INVENTION

In general, a steering column supports a steering shaft relative to a car body for transmitting operational force from the steering wheel to the steering gear box. When an accident takes place, the steering column collapses in order to either prevent or reduce injury to a driver.

Accordingly, the steering column firmly supports the steering shaft for optimally restricting vibration of the steering wheel whereby a driver can smoothly operate the steering wheel, and the collapse operation functions properly during an accident.

### SUMMARY OF THE INVENTION

Embodiments of the present invention provide a steering column structure of a vehicle configured to smoothly activate the collapse operation of the steering column and thereby prevent an upper shroud from interfering with a crash pad when a collision occurs. As such, the driver's knees are limited from touching the shroud. The vibration and noise of a steering wheel can be reduced by stably securing an upper side of a steering shaft.

In accordance with one embodiment of the present invention, a steering column structure of a vehicle comprises an upper shroud placed toward an upper part of a steering column, whose top section is parallel or tapers off from a part contacting a crash pad toward an operational line of the steering column collapse. A lower shroud is formed with a depression at a place near a driver's knees and a central part of the steering column.

The steering column structure of a vehicle further comprises a column tube supportably enclosing a steering shaft at the inner side of the upper shroud and lower shroud. A bracket is mounted at a circumferential part of the lateral surface of the column tube. A switch lever is installed via the bracket.

The steering column structure of a vehicle still further comprises a bearing installed between the column tube and the steering shaft at an upper side of the steering column, wherein the bearing is installed where the distance from an upper side of the steering shaft is less than or equal to 3.0 times the maximum diameter of the steering shaft.

In a further alternative embodiment, a steering column structure for a vehicle has an operational line generally lying along a centrally disposed steering shaft, with a crash pad disposed above the steering shaft. An upper shroud is preferably disposed at least partly between the steering shaft and the crash pad, and has a top section contacting a lower portion of the crash pad and extending upwardly, substantially along the operational line. A lower shroud is disposed under the steering shaft, defining a depression configured and dimensioned to receive a driver's knees along a central part of the steering column. The steering column structure preferably comprises a column tube formed around the steering shaft inside the upper and lower shrouds. A bracket is disposed along a circumferential part of the tube, and a switch component is received in the bracket.

### BRIEF DESCRIPTION OF THE DRAWINGS

For fuller understanding of the nature and objects of the present invention, reference should be made to the following detailed description taken in conjunction with the accompanying drawings in which:

FIG. 1 is a cross-sectional view illustrating a steering column structure of a vehicle according to an embodiment of the present invention; and

FIG. 2 is an enlarged cross-sectional view illustrating an upper portion of a steering column structure according to an embodiment of the present invention.

### DETAILED DESCRIPTION OF THE INVENTION

Hereinafter, the preferred embodiment of the present invention will be described in detail with reference to the accompanying drawings.

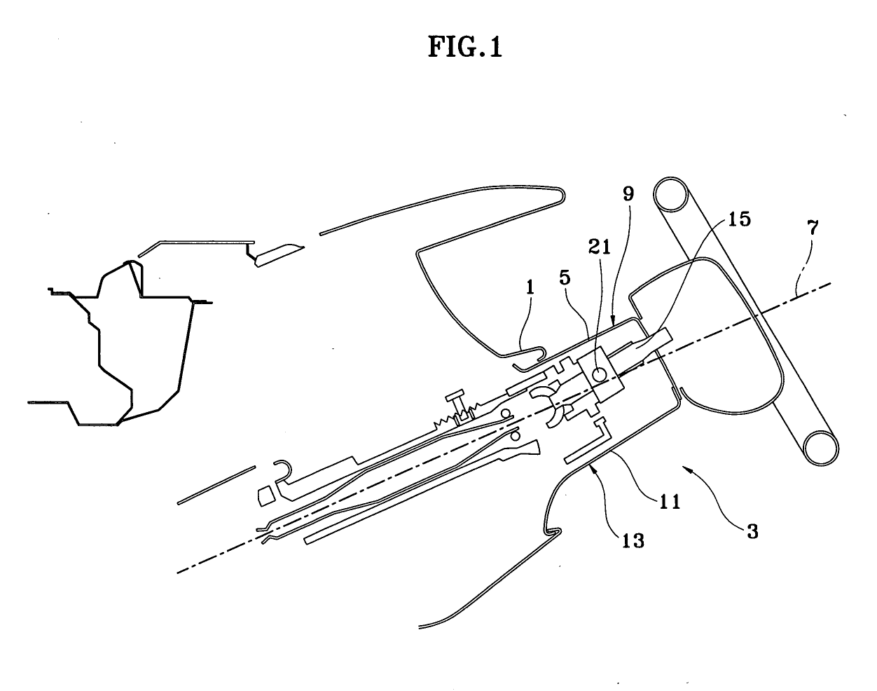

FIG. 1 illustrates a steering column structure of a vehicle according to one embodiment of the present invention, wherein the structure comprises an upper shroud 9 and a lower shroud 13. The upper shroud 9 is placed toward an upper part of a steering column 3, whose top section 5 is parallel or tapers off from a part contacting a crash pad 1 toward an operational line 7 of the steering column collapse. The lower shroud 13 is formed with a depression 11 at a place adjacent to the driver's knees and a central part of the steering column 3.

When the top section 5 is formed either parallel to or tapers off toward the operational line 7 thus described, the upper shroud 9 can be moved to the lower side of the steering column 3 along the operational line 7 without any interference with the crash pad 1 when the steering column 3 collapses during a vehicle collision, allowing the steering column 3 to collapse properly.

Further, the depression 11 formed at the lower shroud 13 is designed so as to allow the driver to have enough space to freely move his or her knees and prevent the knees from being impacted by the lower shroud 13 or minimize impact when a vehicle collision occurs, thereby minimizing injury to the knees and femoral regions of a driver.

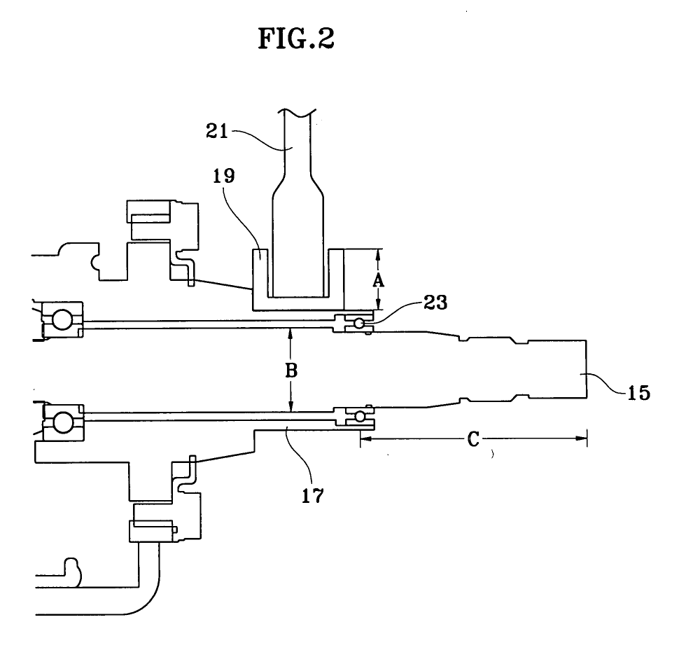

As shown in FIG. 2, the upper shroud 9 and the lower shroud 13 include therein a column tube 17 supportably formed around a steering shaft 15, a bracket 19 mounted at a circumferential part of the column tube 17, and a switch lever 21 mounted via the bracket. The bracket 19 is formed with a height (A) shorter than the maximum diameter (B) of the steering shaft 15. The height (A) extends toward the side of the column tube 17, and the upper and lower shrouds 9 and 13 are installed close to the steering shaft 15. In other words, each protrusive lateral height (A) of the bracket 19 installed inside the upper and lower shrouds 9 and 13 is smaller than the diameter (B) such that the top section 5 of the upper shroud 9 may get closer to the operational line 7 as the section goes upwards, and the lower shroud 13 can be mounted with the depression 11.

Either a turn switch lever or a wiper switch lever, or both, can be used as a switch lever 21 which is typically mounted in a vehicle. The turn switch lever and the wiper switch lever are installed at both sides of the steering column 3 via the bracket 19.

With reference to a structure where the column tube 17 supports the steering shaft 15, an upper side of the steering shaft 15 is supported at the upper side of the steering column 3 via a bearing 23 installed between the column tube 17 and the steering shaft 15. More particularly, the bearing 23 is positioned at a place where the distance (C) from the upper side of the steering shaft 15 is within three times of the maximum diameter (B) of the steering shaft 15.

The bearing 23 is mounted as close as possible to the upper side of the steering shaft 15 in order to optimally reduce vibration of the upper side of the steering shaft 15. The reason the bearing 23 can be installed at a proper location thus described is that the bracket 19 is mounted at a circumference of the column tube 17 for installing the switch lever 21.

As apparent from the foregoing, there is an advantage in embodiments of the present invention in that a crash pad and an upper shroud do not interfere with each other, resulting in a smooth collapse of a steering column during a vehicle collision, thereby minimizing injury to the driver's chest or face upon impact to the steering wheel. There is another advantage in that the distance between a lower shroud and a driver's knees is lengthened to prevent the knees from hitting the lower shroud and minimize injury to the driver's knees or femoral regions even if the driver's knees are hit. There is still another advantage in that a bearing placed as close as possible to an upper side of a steering shaft can reduce vibration and noise of the steering wheel while a vehicle is in motion or runs idle.

What is claimed is:

1. A steering column structure of a vehicle, the structure comprising:
an upper shroud disposed toward an upper part of a steering column, the upper shroud having a top section parallel or tapering off from a part contacting a crash pad toward an operational line of said steering column collapse; and
a lower shroud formed with a depression at a place near a driver's knees and a central part of said steering column.

2. The structure as defined in claim 1, further comprising:
a column tube supportably formed around a steering shaft at an inner side of said upper shroud and said lower shroud;
a bracket installed at a circumferential part of said column tube; and
a switch lever installed via said bracket.

3. The structure as defined in claim 2, wherein said bracket has a height laterally extending from said column tube that is smaller than a maximum diameter of said steering shaft.

4. The structure as defined in claim 2, wherein said switch lever is a turn switch lever.

5. The structure as defined in claim 2, wherein said switch lever is a wiper switch lever.

6. The structure as defined in claim 2, wherein a bearing is disposed between said column tube and said steering shaft at an upper side of said steering column is placed at a distance from the upper side of said steering shaft less than or equal to three times of a maximum diameter of said steering shaft.

7. A steering column structure for a vehicle wherein the steering column has an operational line, said structure comprising:
a centrally disposed steering shaft;
a crash pad disposed above the steering shaft;
an upper shroud disposed at least partly between the steering shaft and crash pad, the upper shroud having a top section contacting a lower portion of the crash pad and extending upward, substantially along the operational line; and
a lower shroud disposed under the steering shaft and defining a depression configured and dimensioned to receive a driver's knees along a central part of the steering column.

8. The structure of claim 7, further comprising:
a column tube formed around the steering shaft inside the upper and lower shrouds;
a bracket disposed along a circumferential part of said tube; and
a switch component received in said bracket.
